(19) United States
(12) Patent Application Publication
(10) Pub. No.: US 2021/0357678 A1
(43) Pub. Date: Nov. 18, 2021

(54) INFORMATION PROCESSING METHOD AND APPARATUS, AND STORAGE MEDIUM

(71) Applicant: SHENZHEN SENSETIME TECHNOLOGY CO., LTD., Shenzhen (CN)

(72) Inventors: Xiaotong LI, Shenzhen (CN); Yiren ZENG, Shenzhen (CN); Xuyang YAN, Shenzhen (CN); Xiaoling ZENG, Shenzhen (CN); Tong GUO, Shenzhen (CN)

(21) Appl. No.: 17/386,490

(22) Filed: Jul. 27, 2021

Related U.S. Application Data
(63) Continuation of application No. PCT/CN2020/089594, filed on May 11, 2020.

(30) Foreign Application Priority Data
Jun. 28, 2019 (CN) 201910577496.1

(51) Int. Cl. G06K 9/62; G06K 9/32; G06F 16/55; G06F 16/583; G06F 16/587

(52) U.S. Cl. CPC G06K 9/6211; G06K 9/3233; G06K 9/6218; G06K 9/6204; G06K 2209/21; G06F 16/55; G06F 16/583; G06F 16/587; G06K 9/6274

(57) ABSTRACT

An information processing method and apparatus, and a storage medium, the method including: on the basis of aggregated archive data, determining a target object; acquiring first capture image information of the target object; analysing the first capture information to obtain a first analysis result; and, on the basis of the first analysis result, determining a first trajectory of the target object.

### CROSS-REFERENCE TO RELATED APPLICATIONS

This is a continuation application of International Patent Application No. PCT/CN2020/089594, filed on May 11, 2020, which claims priority to Chinese Application No. 201910577496.1, filed on Jun. 28, 2019. The disclosures of International Patent Application No. PCT/CN2020/089594 and Chinese Application No. 201910577496.1 are hereby incorporated by reference in their entireties.

### BACKGROUND

When the public security department conducts daily investigations, it is necessary for staff to manually research, judge, and select capture pictures one by one before resolving the activity track of a target suspect, which is of heavy workload and time-consuming Therefore, there is a pressing need for a solution for quickly determining a suspect's activity track.

### SUMMARY

The subject disclosure relates to the field of information processing, and more particularly, to a method and device for information processing, and a storage medium.

Embodiments herein provide a method and device for information processing, and a storage medium, at least capable of automatically analyzing and counting the capture image information of the target object and forming a track.

According to a first aspect herein, a method for information processing includes: determining a target object based on aggregated profile data; acquiring first capture image information of the target object; analyzing the first capture image information to obtain a first analysis result; and determining a first track of the target object according to the first analysis result. The first analysis result includes appearing information of the target object.

According to a second aspect herein, a device for information processing includes: a determining module, an acquiring module, an analyzing module and a processing module. The determining module is configured to determine a target object based on aggregated profile data. The acquiring module is configured to acquire first capture image information of the target object. The analyzing module is configured to acquire a first analysis result by analyzing the first capture image information. The processing module is configured to determine a first track of the target object according to the first analysis result. The first analysis result includes appearing information of the target object.

According to a third aspect herein, a device for information processing includes: memory, a processor, and computer programs stored in the memory and executable on the processor. When the computer programs are executed by the processor, the processor is configured for implementing operations of the method for information processing herein.

According to a fourth aspect herein, a computer storage medium has computer programs which stored thereon, when the computer programs are executed by a processor, the processor is configured to implement operations of the method for information processing herein.

According to a fifth aspect herein, a computer program includes computer-readable codes which, when run on electronic equipment, a processor of the electronic equipment is configured to implement operations of the method for information processing herein.

The general description above and the elaboration below are exemplary and explanatory only, and do not limit the subject disclosure.

### BRIEF DESCRIPTION OF THE ACCOMPANYING DRAWINGS

Drawings here are incorporated in and constitute part of the description, illustrate embodiments according to the subject disclosure, and together with the description, serve to explain the technical solution of the subject disclosure.

FIG. 1 is a flowchart of establishing a profile according to embodiments of the present disclosure.

FIG. 2 is a diagram of a principle of a capture image database clustering algorithm according to embodiments of the present disclosure.

FIG. 3 is a flowchart of a method for information processing according to embodiments of the present disclosure.

FIG. 4 is a diagram of an interface for querying captured points corresponding to captured records according to embodiments of the present disclosure.

FIG. 5 is a diagram of an interface for querying a target track corresponding to captured records according to embodiments of the present disclosure.

FIG. 6 is a diagram of an interface for querying a companion social network for companion analysis according to embodiments of the present disclosure.

FIG. 7 is a diagram of an interface for filtering a companion for companion analysis according to embodiments of the present disclosure.

FIG. 8 is a diagram of tracks of a target object and a companion according to embodiments of the present disclosure.

FIG. 9 is a diagram of clicking on a video source point for details according to embodiments of the present disclosure.

FIG. 10 is a diagram 1 of companion points of a target object and a companion according to embodiments of the present disclosure.

FIG. 11 is a diagram 2 of companion points of a target object and a companion according to embodiments of the present disclosure.

FIG. 12 is a diagram of a structure of a device for information processing according to embodiments of the present disclosure.

### DETAILED DESCRIPTION

Exemplary embodiments, characteristics, and aspects herein are elaborated below with reference to the drawings. Same reference signs in the drawings may represent elements with the same or similar functions. Although various aspects herein are illustrated in the drawings, the drawings are not necessarily to scale unless expressly pointed out otherwise.

The dedicated word “exemplary” may refer to “as an example or an embodiment, or for descriptive purpose”. Any embodiment illustrated herein as being “exemplary” should not be construed as being preferred to or better than another embodiment.

A term “and/or” herein merely describes an association between associated objects, indicating three possible relationships. For example, by A and/or B, it may mean that there may be three cases, namely, existence of but A, existence of both A and B, or existence of but B. In addition, a term “at least one” herein means any one of multiple, or any combination of at least two of the multiple. For example, including at least one of A, B, and C may mean including any one or more elements selected from a set composed of A, B, and C.

Moreover, a great number of details are provided in embodiments below for a better understanding of the subject disclosure. A person having ordinary skill in the art may understand that the subject disclosure may be implemented without some details. In some embodiments, a method, means, an element, a circuit, etc., that is well-known to a person having ordinary skill in the art may not be elaborated in order to highlight the main point of the subject disclosure.

In order to better explain the present disclosure, some existing profile establishing methods are introduced below.

A conventional method for automatically establishing a personnel profile is to classify the capture image information of the same person one by one through a 1:N comparison. This method has a low recall rate and a low speed, and it is difficult to adapt to a scenario with large-scale massive data.

Based on this, the present disclosure proposes a method for establishing profile data based on cluster analysis.

The technical solution of the present application will be further elaborated below with reference to the drawings and specific embodiments.

In some optional embodiments, the establishment of aggregated profile data based on clustering analysis includes: performing clustering processing on image data in a first database to obtain a clustering processing result, the first database being formed based on portrait images captured by an image collecting device; performing aggregation processing on image data in a second database to obtain an aggregation processing result, the second database being formed based on real-name image information; and performing association analysis on the clustering processing result and the aggregation processing result to obtain aggregated profile data.

In this way, all profile information of a person in the system may be acquired.

For example, contents of massive collected videos may be processed. Feature extraction may be performed on a captured face image. By comparing with the second database, if a matching rate is greater than a threshold, a face image with the highest matching rate is considered as a found face photo by default, and is associated with personal information such as a name, an identity number, photo capture time and location, etc., of a corresponding person. The face photo and corresponding personal information are stored as one-profile-per-person data, thereby the quantification of information may be implemented on each person in the video, and big data analysis may be provided to assist a relevant department in solving a case.

In some optional implementations, the operation of performing clustering processing on the image data in the first database may include: extracting face image data from the image data in the first database; and dividing the face image data into multiple classes. Each of the multiple classes may have a class center. The class center may include a class center feature value.

In this way, a method for clustering faces in many portraits of capture images is given. That is, the collection of faces is divided into multiple classes composed of similar faces, and a class generated by the clustering is a collection of a set of data objects. These objects are similar to objects in the same class, but different from objects in other classes.

Specifically, an existing clustering algorithm may be used to divide the face image data into multiple classes.

In some optional embodiments, the operation of performing aggregation processing on the image data in the second database to obtain the aggregation processing result includes: aggregating image data with a same identity number into an image database; and establishing an association between the image database and text information corresponding to the identity number to obtain an aggregation processing result. Each identity number in the aggregation processing result may correspond to unique profile data.

In other words, in the second database, data of the same identity number may be aggregated into one profile.

In some optional embodiments, the operation of performing association analysis on the clustering processing result and the aggregation processing result includes: performing full comparison on each class center feature value in the first database with each reference class center feature value in the second database to obtain a full comparison result; determining, based on the full comparison result, a target reference class center feature value with a highest similarity greater than a preset threshold; searching the second database for a target portrait corresponding to the target reference class center feature value and identity information corresponding to the target portrait; and establishing an association between the identity information corresponding to the target portrait and an image corresponding to the each class center feature value in the first database.

In this way, identity information corresponding to an image with a highest similarity is assigned to a class of the capture image database, providing the real name of the class of capture image portraits.

In the above solution, optionally, the method may further include: in response to adding new image data to the first database, performing clustering processing on the new image data to divide face image data in the new image data into multiple classes, and querying whether there is a class in the first database same as one of the multiple classes; in response to there being a class same as a first class in the multiple classes, merging image data of the first class into an existing profile of the first class; and in response to there being no class same as a second class in the multiple classes, establishing a new profile based on the second class, and adding the new profile to the first database.

Here, the existing profiles of the first class are profiles of the first class existed in the first database, and each class corresponds to a unique profile in the first database.

In this way, when there is a new increase in the database, the profile data in the system may be updated or supplemented in time.

In the above solution, optionally, the method may further include: in response to adding new image data to the second database, querying whether there is an identity number in the second database same as the new image data; in response to there being a first identity number same as first image data in the new image data, merging the first image data into an existing profile corresponding to the first identity number; and in response to there being not a second identity number same as second image data in the new image data, establishing a new profile based on the second identity number in the second image data, and adding the new profile to the second database

Here, the existing profile corresponding to the first identity number is a profile of the first identity number existed in the second database. In the second database, each identity number corresponds to a unique profile.

In this way, when there is a new increase in the database, the system profile data may be updated or supplemented in time.

The above-mentioned profile establishing methods may automatically classify massive capture image pictures, and may automatically associate massive suspect capture images in video surveillance with information in existing public security personnel database, implementing one-profile-per-person data storage based on face clustering, quantifying information on each person in the video, and providing big data analysis to assist a relevant department in solving a case.

To facilitate understanding, the first database may be referred to as a capture image database or a capture portrait database, which is formed based on the portrait images captured by the image collecting device; the second database may be referred to as a portrait database or a static portrait database, which is formed based on demographic information of citizens who have been authenticated by real names, such as identity numbers.

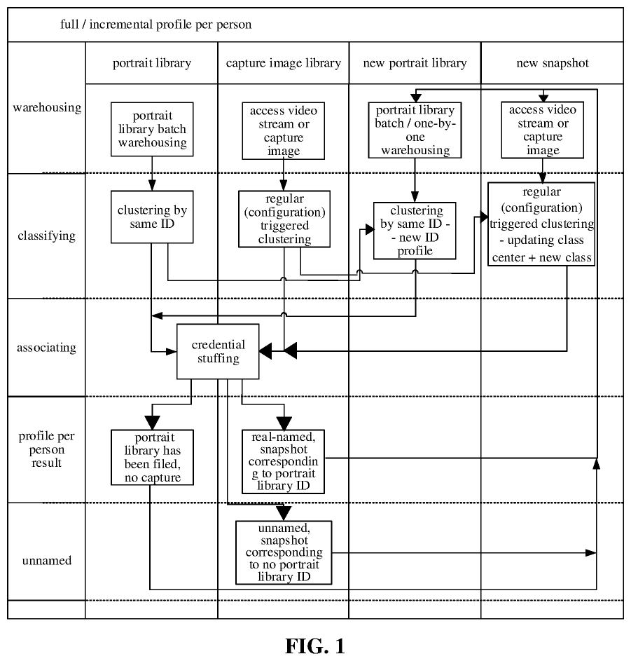

FIG. 1 is a flowchart of establishing a profile according to embodiments of the present disclosure. As shown in FIG. 1, the flow mainly includes four operations of: capture image database clustering, portrait database aggregation, capture image database and portrait database collision, and incremental database collision.

1. Capture image database clustering:

1) Capture image database clustering is automatically triggered regularly by the system;

2) Firstly full clustering, then incremental clustering, and aggregation to existing clusters;

3) When there is no similar class, a new class may be automatically aggregated.

Specifically, for the capture image database, a batch of capture images are stored in the database, or a video stream is accessed, and clustering is triggered at regular intervals, such as once an hour or once a day. The time is configurable. It is full clustering at first, and then incremental clustering for aggregation into an existing class, or automatic aggregation into a new class when there is no similar class.

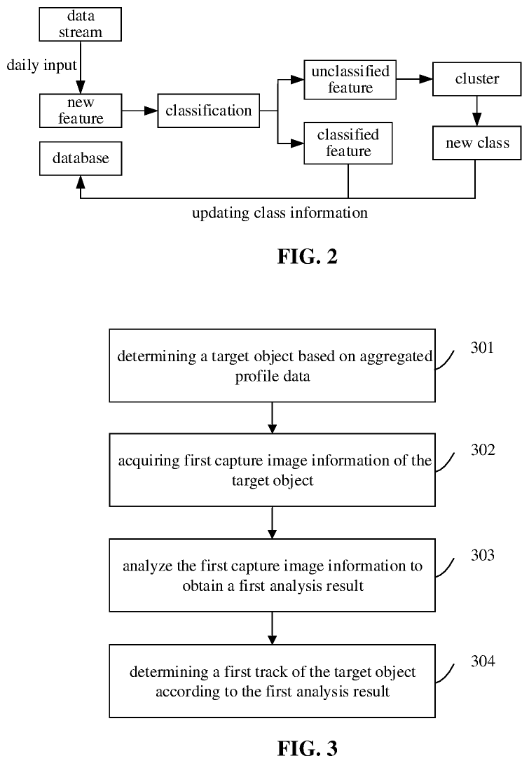

FIG. 2 is a diagram of a principle of a capture image database clustering algorithm according to embodiments of the present disclosure. As shown in FIG. 2, the daily input data stream is analyzed to obtain new features; the new features are classified. A new feature of an existing class is clustered into the existing class, and a class center of the base database is updated. A new feature of no class is clustered into a new class, and the new class is added to the class centers of the base database.

2. Portrait database aggregation:

1) In case there is an identity number,

portraits with the same identity number in the portrait database are aggregated into one profile, with the identity ID as a unit.

A case where the same person in the portrait database has multiple IDs is not processed and treated as multiple profiles.

2) In case there is no identity number,

If there is no identity ID number, the identity number will be considered as 0000000000000000 by default. In this case, each portrait forms a separate profile.

Specifically, for a portrait database, a batch of portraits are stored in the database, and portraits with the same identity number are aggregated into one profile.

3. Capture image database and portrait database collision:

1) After clustering, the capture image database is divided into multiple classes (of people), and each class has a class center, which corresponds to a class center feature value;

2) 1: n full comparison is then performed on the center feature value of each class with the portrait database, and a portrait with TOP1 similarity greater than a preset threshold (such as 95%) is selected;

3) The identity information corresponding to the TOP1 portrait is assigned to the class of the capture image database, associating the class of capture image portraits with a real name.

Specifically, the capture image database is divided into multiple classes (of people) after clustering. Each class has a class center, which corresponds to a class center feature value. 1: n full comparison is then performed on each class center feature value with the portrait database. The identity information corresponding to the image with the highest similarity is assigned to the class of the capture image database, associating the class of capture image portraits with a real name.

4. Incremental database collision

1) Capture image database increment

a. Incremental clustering is performed on the capture image database regularly every day;

b. Class, which may be clustered into an existing class, is merged into the existing profile, and the class center is updated;

c. Database collision operation is performed on the portrait database with an updated class;

d. A capture image that cannot be clustered into any existing class is put into a new class, forming a new profile;

e. Database collision operation is performed on the portrait database with the class center of the new class;

f. If a database collision result includes the TOP1 above the preset threshold, the class is associated with the real name in the identity information of the portrait, and merged with the profile;

g. If there is no hit from the database collision, the class is added to an unnamed class.

2) Portrait database increment

a. Identity information (identity number) associated query is performed on the existing portrait database. If identity information of increment is the same as a profile, the increment is merged into the profile;

b. If identity information of increment is not found, a new profile is established;

c. Database collision operation is performed with the class center of the capture image database;

d. If a database collision result includes the TOP1 above the preset threshold, the class is associated with the real name in the identity information of the portrait, and merged with the profile;

e. If there is no hit from the database collision, the class is added to a profiled no-capture image class.

Specifically, new portraits may be stored in the database in batch or one by one. It is queried whether there is an identity number in existing profiles in the portrait database that is the same as a new portrait. If so, the new portrait is aggregated into the profile under the same identity number; if there is no identity number same as the new portrait, a new profile is established for the new portrait. New capture images may be stored in the database in batch or one by one, or a video stream is accessed. Clustering is triggered at regular intervals. It is queried whether there is a class in existing profiles in the capture image database being the same as the new capture images. If so, the new capture images are aggregated into a profile under the same class; if there is no class same as the new capture images, a new profile is established for the new capture images. Database collision operation is performed on the portrait database with the class center of the new class.

It may be seen that the portrait database with citizen IDs is used as a reference database. Face capture images with time and space information captured by a capture image machine are clustered. Pairwise similarity is used as the criterion to associate information in the face recognition system seemingly of one person, so that one person has a unique comprehensive profile. An attribute feature, a behavioral feature, etc., of a suspect may be acquired from the profiles.

In this way, conditional filtering is performed on all clustered (including real-named and unnamed) profiles, finding out the profile information of a person the number of capture images of whom in the specified video source within the specified time range exceeds a certain threshold. After acquiring the profile information, the user may quickly find the companion accompanying the suspect in an area within a period from t seconds before till t seconds after according to portrait information of the suspect, and eligible companion capture images are aggregated; Or, the detailed companion record of the suspect Q accompanied by a single companion G may be inquired based on a number of companion times of the companion, to determine the companion records and companion social networks of some suspects.

Compared with the existing problem that it is difficult to achieve efficient automatic classification under a massive data scenario, the present disclosure may automatically classify massive capture images, and may also automatically associate massive suspect capture images in video surveillance with information in existing public security personnel database efficiently.

The above-mentioned method for automatically generating a personnel profile based on clustering utilizes a face incremental clustering algorithm and a face and human body joint clustering algorithm, thereby improving clustering effect. Further, use of a Graphics Processing Unit (GPU) for parallel operation may ensure sufficient computing power to adapt to a large-scale data scenario.

Based on the above-mentioned scheme for automatically generating a personnel profile, embodiments of the present application propose a scheme for information processing based on system profile data.

The embodiments of the present application provide a method for information processing. As shown in FIG. 3, the method mainly includes the following operations.

In S301, a target object is determined based on aggregated profile data.

Exemplarily, a terminal acquires a target image from a system database, and determines a target object based on the target image.

The system database stores aggregated profile data established based on cluster analysis.

In embodiments herein, the system database includes at least a first database and a second database. The first database is formed based on portrait images captured by an image collecting device. The second database is formed based on real-name image information.

In S302, first capture image information of the target object is acquired.

In the embodiments, the first capture image information is collected by an image collection device. The image collecting device has an image acquisition function. For example, the image collecting device may be a camera or a snapshot machine.

In some optional implementations, the operation of acquiring the first capture image information of the target object includes: receiving the capture image information sent by each image collecting device; analyzing the capture image information to acquire first capture image information of the target object.

As an implementation, the image capture image device may send the collected capture image information to the terminal periodically, or may send the collected capture image information to the terminal when receiving a transmission instruction sent by the terminal; further, it may also send, to the terminal, the capture image information of the specified area within the specified time period according to the requirement of a transmission instruction.

In some other optional implementations, the operation of acquiring the first capture image information of the target object includes: reading, from a memory, the capture image information collected by each image collecting device; analyzing the capture image information to acquire the first capture image information of the target object.

Here, the memory is a memory that stores capture image information and may be connected to the terminal.

It should be noted that embodiments herein does not limit a mode for acquiring the first capture image information of the target object.

In S303, a first analysis result is acquired by analyzing the first capture image information.

The first analysis result includes appearing information of the target object.

In some optional embodiments, the operation of acquiring analyzing the first capture image information to obtain the first analysis result may include: determining a to-be-analyzed capture image based on the first capture image information; determining the appearing information of the target object in each of the capture images, the appearing information comprising at least an appearing geographic location and an appearing time; and counting, based on the appearing information, a number of appearances of the target object in a same geographic location.

In this embodiment, the first capture image information includes at least multiple capture images, and the capture images carry capture time information. Optionally, the first capture image information also carries information of an image collecting device that captures the capture images. It should be noted that each image collecting device has an identifier that uniquely characterizes the image collecting device.

In some specific implementations, the operation of determining to-be-analyzed capture images based on the first capture image information may include: filtering out the to-be-analyzed capture images according to a time requirement.

Here, the time requirement may be set or adjusted according to a user requirement or a design requirement.

For example, the time requirement may be that the capture image corresponding to time t0 is set as the starting time point, and a capture image is selected every d seconds. Thereby, multiple images, such as the capture image corresponding to time t0, the capture image corresponding to time t0+d, the capture image corresponding to time t0+2d, . . . , the capture image corresponding to time t0+xd, etc., are selected.

In some specific embodiments, determining to-be-analyzed capture images based on the first capture image information may include: filtering out the to-be-analyzed capture images according to the identification information of the image collecting device.

For example, there are a total of 10 cameras in a community B of a city A, denoted respectively by cameras 1, 2, 3, 4, 5, 6, 7, 8, 9, and 10. Capture images collected by cameras 1, 3, 5, 7, and 9 are selected as the to-be-analyzed capture images.

In some other optional implementations, the operation of analyzing the first capture image information to obtain the first analysis result may further include: establishing a correspondence between each of the capture images and the appearing information in each of the capture images.

This helps query the activity track of the target object based on a single capture image.

In some other optional implementations, analyzing the first capture image information to obtain the first analysis result further include: establishing an association of each of the capture images with M neighboring capture images previous and following the capture image. M is a positive number.

This helps query a capture image related to a single capture image subsequently.

For example, according to the analysis of the capture image a2, the appearing information of the target object F is: a geographic location c2, and appearing time t2, and an association of the capture image a2 with its neighboring capture images a1, a0, a3, and a4 is established. When querying a single capture image, such as the capture image a2, the information acquired from the analysis of the single image may be displayed, and the neighboring capture images may be quickly found, which helps infer the target object's track.

In S304, a first track of the target object is determined according to the first analysis result.

In some optional implementations, the operation of determining a first track of the target object according to the first analysis result may include: marking, on an electronic map based on the appearing information of the target object, appearing points and the numbers of appearances of the target object; and connecting appearing points on the electronic map according to the appearing time to form the first track.

In this way, marking the numbers of appearances of the target object at each appearing points may clearly show the frequency of appearance at each appearing point, which helps find the permanent location of the target object; connecting each appearing points according to the appearing time may acquire the track of the target object in a certain period of time, which helps track and find the target object.

In the above solution, the method may further include: determining at least one companion of the target object based on the aggregated profile data, the at least one companion being at least one person, other than the target object, that appears in a capture images, that capture the target object, captured within a period from t seconds before a target time point till t seconds after the target time point by an image collecting device, the target time point being a time point when the image collecting device captures the target object; acquiring second capture image information of the at least one companion; analyzing the second capture image information to obtain a second analysis result; and determining at least one second track of at least one companion according to the second analysis result. The second analysis result may include appearing information of the at least one companion.

In some optional implementations, the at least one companion may also be at least one person, other than the target object, that appears in capture images, that captures the target object, captured within a period from t seconds before a target time point till t seconds after the target time point by an image collecting device, with a clustered number of appearances exceeding a preset value. The t may be a positive number.

In this way, the scope of the at least one companion may be reduced.

Here, the track of at least one companion may be determined referring to the method for determining the track of the target object. Implementation of each operation is not repeated here.

In the above solution, optionally, the method may further include: determining a first companion among the at least one companion of the target object; retrieving a second track of the first companion; and performing comparative display on the first track of the target object and the second track of the first companion.

In this way, the first track of the target object and the second track of a certain companion are displayed at the same time. After locking a certain companion, comparison of the tracks of the target and the companion on the map is checked, and the companion points of the two are displayed, etc., thereby confirming the relation between the two, and predicting an action, etc.

Interface display of track analysis of the target object and its companions is exemplified below.

1. The track of the target object:

1) Under the tag Capture Record, points where the target appears are displayed on the map. The “Show Track” button is clicked on to connect the points to form a track.

2) The number of appearance times at each point is displayed, and the three points of “first appearance”, “last appearance”, and “frequented point” are counted and displayed.

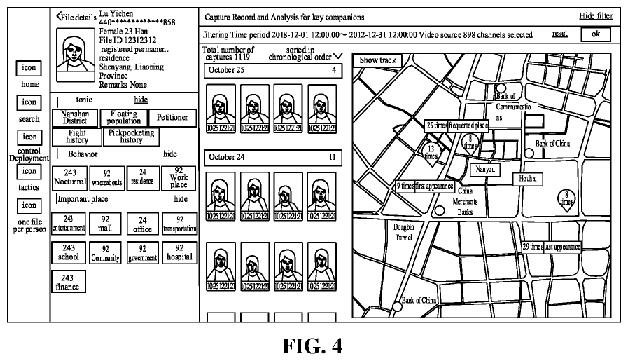

FIG. 4 is a diagram of an interface for querying captured points corresponding to captured records according to embodiments of the present disclosure. As shown in FIG. 4, the personal profile information of the target object, as well as information such as its action data at various places, are displayed on the left side of the figure; the right side of the figure shows captured records of different cameras at different times, as well as information such as the numbers of appearance times at main points on the electronic map.

3) A click on a single point allows viewing a face thumbnail captured at that point, several monitored capture images previous and following, the location of the point and the time when the capture image was captured.

4) Details of the video source at the capture image point may be viewed.

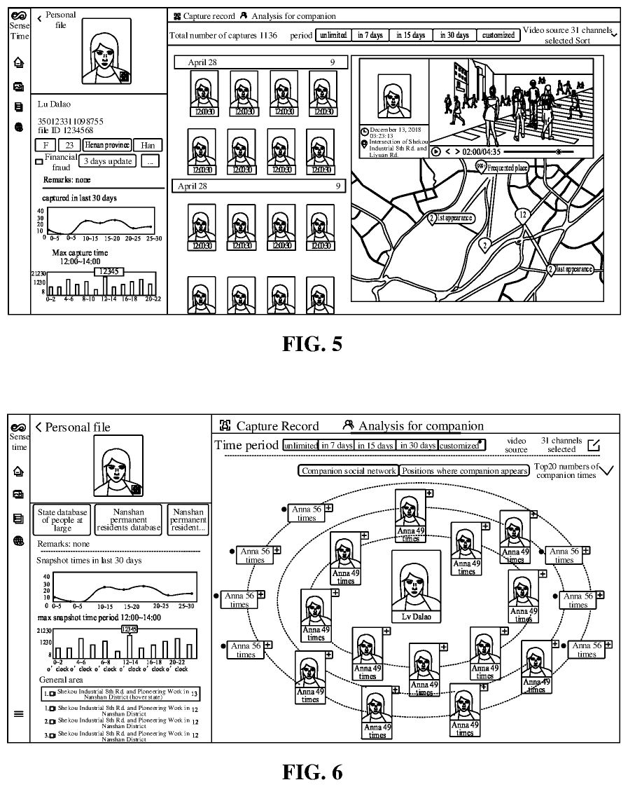

FIG. 5 is a diagram of an interface for querying a target track corresponding to captured records according to embodiments of the present disclosure. As shown in FIG. 5, in the query result interface, the personal profile information of the target object, a curve of the numbers of captures in last 30 days, and a histogram of time periods with max numbers of captures are displayed on the left side of the figure; the right side of the figure shows captured records of different cameras at different times, and the action track formed by a certain captured record such as a video.

2. The companion track:

1) For each capture image of someone, a companion is a person captured, in a n-seconds period before and after the capture image, by the same camera capturing the capture image, whose clustered appearance numbers are greater than a preset value.

FIG. 6 is a diagram of an interface for querying a companion social network for companion analysis according to embodiments of the present disclosure. As shown in FIG. 6, in the query result interface, the left side of the figure shows the avatar of the target object, a curve of the numbers of captures in last 30 days, and a histogram of time periods with max numbers of captures, and the locations of the cameras capturing the companion. The companion social network is shown on the right side of the figure.

2) Switch to the tag Analysis for companion to filter a companion based on a condition.

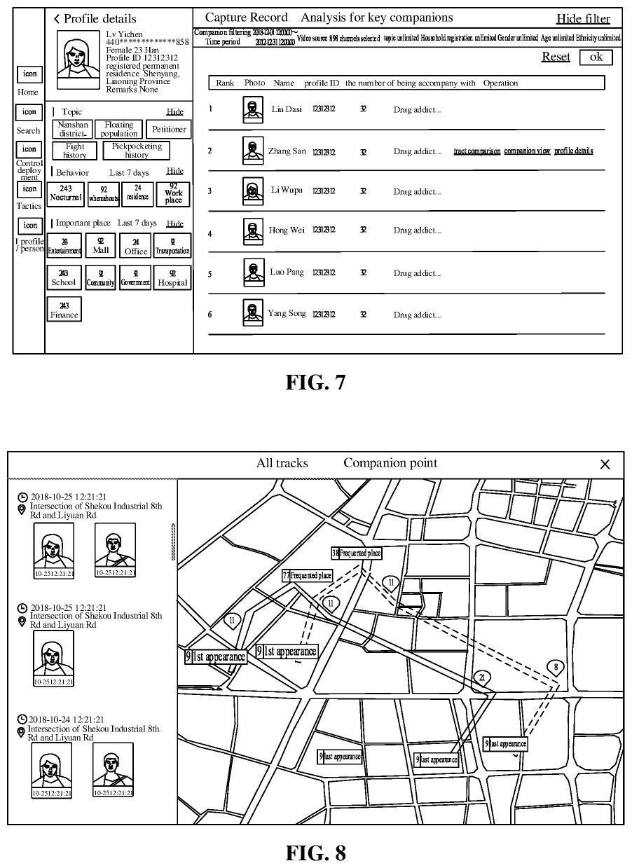

FIG. 7 is a diagram of an interface for filtering a companion for companion analysis according to embodiments of the present disclosure. As shown in FIG. 7, in the query result interface, the personal profile information of the target object, as well as information such as the action data of the target object at various places, are displayed on the left side of the figure; the right side of the figure shows companion information sorted by the number of companion times.

3) Companion track analysis: Select a companion to enter the track page of the companion. The tracks of the profiled person and the companion of the profiled person are displayed on the map under the tag All Tracks. Display of companion capture images and tracks centered on two level companions is supported.

FIG. 8 is a diagram of tracks of a target object and a companion according to embodiments of the present disclosure. As shown in FIG. 8, in the query result interface, the left side of the figure shows video sources capturing the target object and the companion. Tracks of the target object and the companion are displayed on the right side of the figure.

4) Companion track: switching to the tag Companion point, the user may see companion points of the companion and the target on the map. Clicking on a point may display the capture details of the two people walking together.

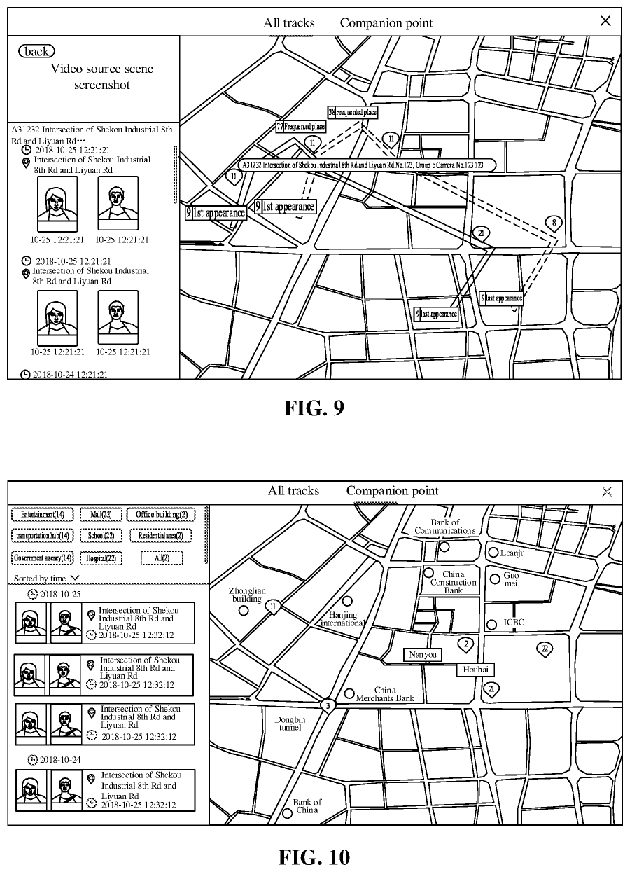

FIG. 9 is a diagram of clicking on a video source point for details according to embodiments of the present disclosure. As shown in FIG. 9, based on tracks shown in FIG. 8, a click on a video source point may play the video source corresponding to the source video point in the upper left corner of the interface.

FIG. 10 is a diagram 1 of companion points of a target object and a companion according to embodiments of the present disclosure. As shown in FIG. 10, after clicking on the companion point tag on the interface, companion points of the two persons are displayed.

FIG. 11 is a diagram 2 of companion points of a target object and a companion according to embodiments of the present disclosure. As shown in FIG. 11, based on the companion points shown in FIG. 10, clicking on a video source point may play the video source corresponding to the video source point in the mid of the interface.

It should be noted that understandably information such as the display content and layout of each aforementioned interface may be set or adjusted according to a user requirement or a design requirement.

It should also be understood that various interfaces listed herein are merely exemplary to help a person having ordinary skill in the art better understand a technical solution herein, and should not be construed as limiting embodiments herein. A person of ordinary skill may make various changes and substitutions to an interface herein. They should also be construed as part of embodiments herein.

The technical solution described in the present disclosure may be applied to fields such as smart video analysis, security monitoring, etc. For example, it may be used to investigate cases such as burglary, anti-terrorism monitoring, medical disturbances, drug-related crackdowns, critical national security, community management and control, etc. For example, once a case has occurred, the police have a portrait photo of a suspect F. The photo of F is uploaded to the profile database of the system, to find the profile of the suspect. The time period during which the crime occurred is set in the Analysis for companion. The profile of a companion who has traveled with the suspect F is found according to video sources around the scene of the crime. The track of the accomplice is shown, thereby confirming the location of the accomplice. After finding the photo of the accomplice, the above operations are repeated to find more possible accomplice photos. This allows the police to connect clues, thereby improving the case solving efficiency.

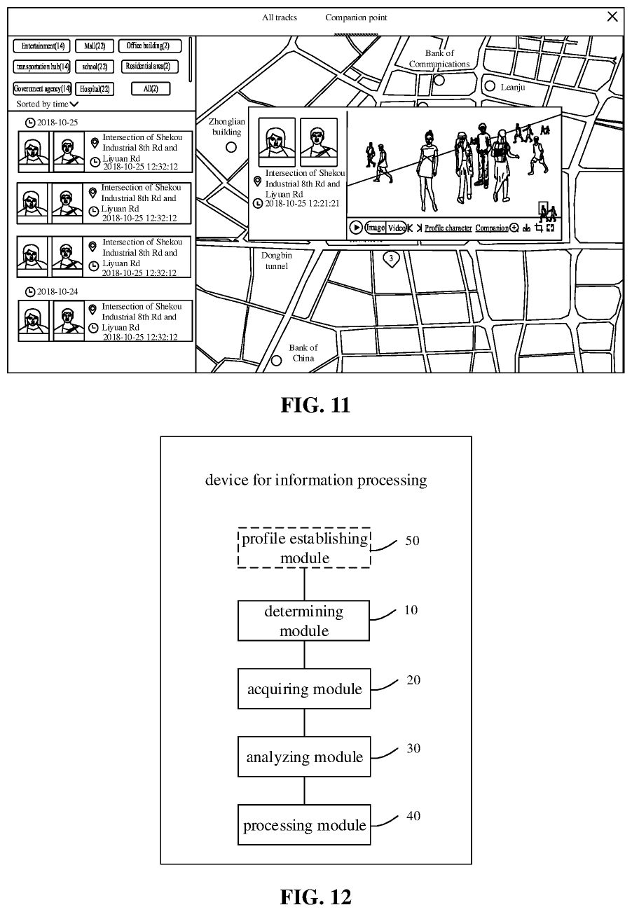

Embodiments of the present application also provide a device for information processing. As shown in FIG. 12, the device includes: a determining module 10, an acquiring module 20, an analyzing module 30 and a processing module 40. The determining module 10 is configured to determine a target object based on aggregated profile data. The acquiring module 20 is configured to acquire first capture image information of the target object. The analyzing module 30 is configured to analyze the first capture image information to obtain a first analysis result. The processing module 40 is configured to determine a first track of the target object according to the first analysis result. The first analysis result includes appearing information of the target object.

As an implementation, the determining module 10 is further configured to determine at least one companion of the target object based on the aggregated profile data. The at least one companion may be at least one person, other than the target object, that appears in a capture images, that capture the target object, captured within a period from t seconds before a target time point till t seconds after the target time point by an image collecting device. The target time point may be a time point when the image collecting device captures the target object. The acquiring module 20 may be further configured to acquire second capture image information of the at least one companion. The analyzing module 30 may be further configured to analyze the second capture image information to obtain a second analysis result. The processing module 40 may be further configured to determine at least one second track of the at least one companion according to the second analysis result. The second analysis result may include appearing information of the at least one companion.

As an implementation, the analyzing module 30 may be further configured to: determine a to-be-analyzed capture image based on the first capture image information; determine the appearing information of the target object in each of the capture images, the appearing information including at least an appearing geographic location and an appearing time; and count, based on the appearing information, a number of appearances of the target object in a same geographic location.

As an implementation, the analyzing module 30 may be further configured to establish a correspondence between each of the capture images and the appearing information in the capture image.

As an implementation, the analyzing module 30 may be further configured to establish an association of each of the capture images with M neighboring capture images previous and following the capture image, M being a positive number.

As an implementation, the processing module 40 may be further configured to: mark, on an electronic map based on the appearing information of the target object, appearing points and the numbers of appearances of the target object; and connecting appearing points on the electronic map according to the appearing time to form the first track.

As an implementation, the processing module 40 may be further configured to: determine a first companion among the at least one companion of the target object; retrieve a second track of the first companion; and perform comparative display on the first track of the target object and the second track of the first companion.

In the above solution, optionally, the device may further include a profile establishing module, which is configured to: perform clustering processing on image data in a first database to obtain a clustering processing result, the first database being formed based on portrait images captured by an image collecting device; perform aggregation processing on image data in a second database to obtain an aggregation processing result, the second database being formed based on real-name image information; and a perform association analysis on the clustering processing result and the aggregation processing result to obtain aggregated profile data.

As an implementation, the profile establishing module 50 may be further configured to: extract face image data from the image data in the first database; and divide the face image data into multiple classes. Each of the multiple classes may have a class center. The class center may include a class center feature value.

As an implementation, the profile establishing module 50 may be further configured to: aggregate image data with a same identity number into an image database; and establishing an association between the image database and text information corresponding to the identity number to obtain an aggregation processing result. Each identity number in the aggregation processing result may correspond to unique profile data.

As an implementation, the profile establishing module 50 may be further configured to: perform full comparison on each class center feature value in the first database with each reference class center feature value in the second database to obtain a full comparison result; determine, based on the full comparison result, a target reference class center feature value with a highest similarity greater than a preset threshold; search the second database for a target portrait corresponding to the target reference class center feature value and identity information corresponding to the target portrait; and establish an association between the identity information corresponding to the target portrait and an image corresponding to the class center feature value in the first database.

As an implementation, the profile establishing module 50 may be further configured for: in response to adding new image data to the first database, perform clustering processing on the new image data to divide face image data in the new image data into multiple classes, and query whether there is a class in the first database same as one of the multiple classes; in response to there being a class same as a first class in the multiple classes, merge image data of the first class into an existing profile of the first class; and in response to there being no class same as a second class in the multiple classes, establish a new profile based on the second class, and add the new profile to the first database.

As an implementation, the profile establishing module 50 may be further configured to: in response to adding new image data to the second database, query whether there is an identity number in the second database same as the new image data; in response to there being a first identity number same as first image data in the new image data, merge the first image data into an existing profile corresponding to the first identity number; and in response to there being not a second identity number same as second image data in the new image data, establish a new profile based on the second identity number in the second image data, and add the new profile to the second database.

A skilled person in the art should understand that, in some optional embodiments, the function of each processing module in the device for information processing shown in FIG. 12 may be understood with reference to the relevant description of the foregoing method for information processing.

A skilled person in the art should understand that in some optional embodiments, the function of each processing unit in the device for information processing shown in FIG. 12 may be implemented by programs running on a processor, or may be implemented by a specific logic circuit.

In a practical application, the specific structures of the determining module 10, the acquiring module 20, the analyzing module 30, the processing module 40, and the profile establishing module 50 described above may all correspond to a processor. The specific structure of the processor may be an electronic component or a collection of electronic components with a processing function, such as a Central Processing Unit (CPU), a Micro Controller Unit (MCU), a Digital Signal Processing (DSP), or a Programmable Logic Controller (PLC). The processor includes executable codes. The executable codes are stored in a storage medium. The processor may be connected to the storage medium through a communication interface such as a bus. When performing a function corresponding to a specific unit, the executable codes in the storage medium are read and run. The part of the storage medium for storing the executable codes is preferably a non-transitory storage medium.

The determining module 10, the acquiring module 20, the analyzing module 30, the processing module 40, and the profile establishing module 50 may be integrated in and correspond to the same processor, or correspond respectively to different processors; when integrated in and correspond to the same processor, the processor processes the functions corresponding to the determining module 10, the acquiring module 20, the analyzing module 30, the processing module 40, and the profile establishing module 50 by time division.

The device for information processing according to embodiments of the present disclosure may automatically analyze and count the capture image information of the target object and form a track. It may also automatically analyze and count the capture image information of a companion and form a track; support viewing comparison of tracks of the target object and the companion on the electronic map, showing companion points of the two, thereby confirming the relation between the two, and predicting an action, etc.

Embodiments of the present application also record a device for information processing. The device includes memory, a processor, and computer programs stored in the memory and executable on the processor. When the computer programs are executed by the processor, the processor is configured for implementing the method according to any aforementioned technical solution.

In embodiments herein, the processor implements, by executing the program:

determining a target object based on aggregated profile data; acquiring first capture image information of the target object; analyzing the first capture image information to obtain a first analysis result; and determining a first track of the target object according to the first analysis result. The first analysis result includes appearing information of the target object.

As an implementation, the processor implements, by executing the program:

determining at least one companion of the target object based on the aggregated profile data. The at least one companion is at least one person, captured t seconds before or after than the target object, captured by the same image collecting device, with a clustered number of appearances exceeding the preset value. The t may be a positive number; the processor implements acquiring second capture image information of the at least one companion; analyzing the second capture image information to obtain a second analysis result; and determining at least one second track of the at least one companion according to the second analysis result. The second analysis result may include appearing information of the at least one companion.

As an implementation, the processor implements, by executing the program: determining a to-be-analyzed capture image based on the first capture image information; determining the appearing information of the target object in each of the capture image, the appearing information including at least an appearing geographic location and an appearing time; and counting, based on the appearing information, a number of appearances of the target object in a same geographic location.

As an implementation, the processor implements, by executing the program: establishing a correspondence between each of the capture images and the appearing information in the capture image.

As an implementation, the processor implements, by executing the program: establishing an association of each of the capture images with M neighboring capture images previous and following the capture image. M may be a positive number.

As an implementation, the processor implements, by executing the program: marking, on an electronic map based on the appearing information of the target object, appearing points and the numbers of appearances of the target object; and connecting appearing points on the electronic map according to the appearing time to form the first track.

As an implementation, the processor implements, by executing the program: determining a first companion among the at least one companion of the target object; retrieving a second track of the first companion; and performing comparative display on the first track of the target object and the second track of the first companion.

As an implementation, the processor implements, by executing the program: performing clustering processing on image data in a first database to obtain a clustering processing result, the first database being formed based on portrait images captured by an image collecting device; performing aggregation processing on image data in a second database to obtain an aggregation processing result, the second database being formed based on real-name image information; and performing association analysis on the clustering processing result and the aggregation processing result to obtain aggregated profile data.

As an implementation, the processor implements, by executing the program: extracting face image data from the image data in the first database; and dividing the face image data into multiple classes, each of the multiple classes having a class center, the class center comprising a class center feature value.

As an implementation, the processor implements, by executing the program: aggregating image data with a same identity number into an image database; and establishing an association between the image database and text information corresponding to the identity number to obtain an aggregation processing result, each identity number in the aggregation processing result corresponding to unique profile data.

As an implementation, when the processor executes the program, it implements: performing full comparison on each class center feature value in the first database with each reference class center feature value in the second database to obtain a full comparison result; determining, based on the full comparison result, a target reference class center feature value with a highest similarity greater than a preset threshold; searching the second database for a target portrait corresponding to the target reference class center feature value and identity information corresponding to the target portrait; and establishing an association between the identity information corresponding to the target portrait and an image corresponding to the class center feature value in the first database.

As an implementation, when the processor executes the program, it implements: in response to adding new image data to the first database, performing clustering processing on the new image data to divide face image data in the new image data into multiple identical classes; in response to there being a class same as a first class in the multiple classes, merging image data of the first class into an existing profile of the first class; and in response to there being no class same as a second class in the multiple classes, establishing a new profile based on the second class, and adding the new profile to the first database.

As an implementation, when the processor executes the program, it is implemented: in response to adding new image data to the second database, querying whether there is an identity number in the second database same as the new image data; in response to there being a first identity number same as first image data in the new image data, merging the first image data into an existing profile corresponding to the first identity number; and in response to there being not a second identity number same as second image data in the new image data, establishing a new profile based on the second identity number in the second image data, and adding the new profile to the second database.

The device for information processing according to embodiments of the present disclosure may automatically analyze and count the capture image information of the target object and form a track. It may also automatically analyze and count the capture image information of a companion and form a track; support viewing comparison of tracks of the target object and the companion on the electronic map, showing companion points of the two, thereby confirming the relation between the two, and predicting an action, etc.

Embodiments of the present application also record a computer storage medium, having stored thereon computer-executable instructions for implementing the method for information processing according to foregoing embodiments. In other words, when the computer-executable instructions are executed by a processor, the processor is configured to implement the method according to any aforementioned technical solution.

A skilled person in the art should understand that the function of each program in the computer storage medium of the embodiments may be understood with reference to relevant description of the method for information processing according to foregoing embodiments. The computer storage medium may be a volatile computer-readable storage medium or a non-volatile computer-readable storage medium.

Embodiments of the present disclosure also provide a computer program product including computer-readable codes which, when on equipment, a processor of the equipment is configured to implement the method according to any aforementioned embodiment.

The computer program product may be specifically implemented by hardware, software or a combination thereof. In an optional embodiment, the computer program product is specifically embodied as a computer storage medium. In another optional embodiment, the computer program product is specifically embodied as a software product, such as a Software Development Kit (SDK), etc.

A skilled person in the art should understand that the function of each program in the computer storage medium of the embodiments may be understood with reference to relevant description of the method for information processing according to foregoing embodiments.

The technical solution described in the present disclosure automatically combines the capture images of the same person in the video surveillance with the existing static personnel database, which allows the police to connect clues, thereby improving the case solving efficiency. For example, when investigating a gang crime, other criminal suspects are found based on the companions. The suspect's social network is learnt by analyzing the suspect's companions, thereby investigating the suspect's identity and whereabouts. Moreover, tracks may be formed by using all capture images of each person. Companion filtering is supported. After locking a companion, comparison of tracks of the target object and the companion on the electronic map is viewed, showing companion points of the two, thereby confirming the relation between the two, and predicting an action, etc.

With the technical solution provided by embodiments of the present disclosure, a target object is determined based on aggregated profile data; first capture image information of the target object is acquired; a first analysis result is acquired by analyzing the first capture image information; and a first track of the target object is determined according to the first analysis result. In this way, the capture image information of the target object may be analyzed and counted automatically and a track may be formed, which improves the speed of determining the track of the target object.

It should also be understood that various interfaces listed herein are merely exemplary to help a person having ordinary skill in the art better understand a technical solution herein, and should not be construed as limiting embodiments herein. A person of ordinary skill may make various changes and substitutions to an interface herein. They should also be construed as part of embodiments herein.

In addition, a technical solution is described herein focusing on differences among the embodiments. Refer to one another for identical or similar parts among the embodiments, which are not repeated for conciseness.

Note that in embodiments provided herein, the disclosed equipment and method may be implemented in other ways. The described equipment embodiments are merely exemplary. For example, the unit division is merely logical function division and can be other division in actual implementation. For example, multiple units or components can be combined, or integrated into another system, or some features/characteristics can be omitted or skipped. Furthermore, the coupling, or direct coupling or communicational connection among the components illustrated or discussed herein may be implemented through indirect coupling or communicational connection among some interfaces, equipment, or units, and may be electrical, mechanical, or in other forms.

The units described as separate components may or may not be physically separated. Components shown as units may be or may not be physical units. They may be located in one place, or distributed on multiple network units. Some or all of the units may be selected to achieve the purpose of a solution of the present embodiments as needed.

In addition, various functional units in each embodiment of the subject disclosure may be integrated in one processing unit, or exist as separate units respectively; or two or more such units may be integrated in one unit. The integrated unit may be implemented in form of hardware, or hardware plus software functional unit(s).

A skilled person in the art may understand that all or part of the operations of the embodiments may be implemented by instructing a related hardware through a program, which program may be stored in a (non-transitory) computer-readable storage medium and when executed, execute steps including those of the embodiments. The computer-readable storage medium may be various media that can store program codes, such as mobile storage equipment, Read Only Memory (ROM), a magnetic disk, a CD, and/or the like.

Alternatively, when implemented in form of a software functional module and sold or used as an independent product, an integrated module herein may also be stored in a (non-transitory) computer-readable storage medium. Based on such an understanding, the essential part or a part contributing to prior art of the technical solution of an embodiment of the present disclosure may appear in form of a software product, which software product is stored in storage media, and includes a number of instructions for allowing computer equipment (such as a personal computer, a server, network equipment, and/or the like) to execute all or part of the methods in various embodiments herein. The storage media include various media that can store program codes, such as mobile storage equipment, ROM, RAM, a magnetic disk, a CD, and/or the like.

What described are embodiments of the present disclosure, but are not intended to limit the scope of the subject disclosure. Any modification, equivalent replacement, and/or the like made within the technical scope of the subject disclosure, as may occur to a person having ordinary skill in the art, shall be included in the scope of the subject disclosure. The scope of the subject disclosure thus should be determined by the claims.

### INDUSTRIAL APPLICABILITY

With the technical solution provided by embodiments of the present disclosure, a target object is determined based on aggregated profile data; first capture image information of the target object is acquired; the first capture image information is analyzed to obtain a first analysis result; and a first track of the target object is determined according to the first analysis result. In this way, the capture image information of the target object may be analyzed and counted automatically and a track may be formed, which improves the speed of determining the track of the target object.

What is claimed is:

1. A method for information processing, comprising:
determining a target object based on aggregated profile data;
acquiring first capture image information of the target object;
analyzing the first capture image information to obtain a first analysis result; and
determining a first track of the target object according to the first analysis result, the first analysis result comprising appearing information of the target object.

2. The method of claim 1, further comprising:
determining at least one companion of the target object based on the aggregated profile data, the at least one companion being at least one person, other than the target object, that appears in capture images, that capture the target object, captured within a period from t seconds before a target time point till t seconds after the target time point by an image collecting device, the target time point being a time point when the image collecting device captures the target object;
acquiring second capture image information of the at least one companion;
analyzing the second capture image information to obtain a second analysis result; and
determining at least one second track of the at least one companion according to the second analysis result, the second analysis result comprising appearing information of the at least one companion.

3. The method of claim 1, wherein analyzing the first capture image information to obtain the first analysis result comprises:
determining a to-be-analyzed capture image based on the first capture image information;
determining the appearing information of the target object in each of the capture images, the appearing information comprising at least an appearing geographic location and an appearing time; and
counting, based on the appearing information, a number of appearances of the target object in a same geographic location.

4. The method of claim 3, wherein the first analysis result further comprises at least one of the following:
correspondence between each of the capture images and the appearing information in the capture image; or
an association of each of the capture images with M neighboring capture images previous and following the capture image, M being a positive number.

5. The method of claim 3, wherein determining the first track of the target object according to the first analysis result comprises:
marking, on an electronic map based on the appearing information of the target object, appearing points and the numbers of appearances of the target object; and
connecting the appearing points on the electronic map according to the appearing time to form the first track.

6. The method of claim 2, further comprising:
determining a first companion among the at least one companion of the target object;
retrieving a second track of the first companion; and
performing comparative display on the first track of the target object and the second track of the first companion.

7. The method of claim 1, further comprising:
performing clustering processing on image data in a first database to obtain a clustering processing result, the first database being formed based on portrait images captured by an image collecting device;
performing aggregation processing on image data in a second database to obtain an aggregation processing result, the second database being formed based on real-name image information; and
performing association analysis on the clustering processing result and the aggregation processing result to obtain aggregated profile data.

8. The method of claim 7, wherein performing clustering processing on the image data in the first database comprises:
extracting face image data from the image data in the first database; and
dividing the face image data into multiple classes, each of the multiple classes having a class center, the class center comprising a class center feature value.

9. The method of claim 7, wherein performing aggregation processing on the image data in the second database to obtain the aggregation processing result comprises:
aggregating image data with a same identity number into an image database; and
establishing an association between the image database and text information corresponding to the identity number to obtain an aggregation processing result, each identity number in the aggregation processing result corresponding to unique profile data.

10. The method of claim 7, wherein performing association analysis on the clustering processing result and the aggregation processing result comprises:
performing full comparison on each class center feature value in the first database with each reference class center feature value in the second database to obtain a full comparison result;
determining, based on the full comparison result, a target reference class center feature value with a highest similarity greater than a preset threshold;
searching the second database for a target portrait corresponding to the target reference class center feature value and identity information corresponding to the target portrait; and
establishing an association between the identity information corresponding to the target portrait and an image corresponding to the class center feature value in the first database.

11. The method of claim 7, further comprising:
in response to adding new image data to the first database, performing clustering processing on the new image data to divide face image data in the new image data into multiple classes;
querying whether there is a class in the first database same as one of the multiple classes;
in response to there being a class same as a first class in the multiple classes, merging image data of the first class into an existing profile of the first class; and
in response to there being no class same as a second class in the multiple classes, establishing a new profile based on the second class, and adding the new profile to the first database.

12. The method of claim 7, further comprising:
in response to adding new image data to the second database, querying whether there is an identity number in the second database same as the new image data;
in response to there being a first identity number same as first image data in the new image data, merging the first image data into an existing profile corresponding to the first identity number; and
in response to there being not a second identity number same as second image data in the new image data, establishing a new profile based on the second identity number in the second image data, and adding the new profile to the second database.

13. A device for information processing, comprising: a memory, a processor, and computer programs stored in the memory and executable on the processor, wherein when the computer programs are executed by the processor, the processor is configured to:
determine a target object based on aggregated profile data;
acquire first capture image information of the target object;
analyze the first capture image information to obtain a first analysis result; and
determine a first track of the target object according to the first analysis result,
the first analysis result comprising appearing information of the target object.

14. The device of claim 13, wherein
the processor is further configured to:
determine at least one companion of the target object based on the aggregated profile data, the at least one companion being at least one person, other than the target object, that appears in capture images, that capture the target object, captured within a period from t seconds before a target time point till t seconds after the target time point by an image collecting device, the target time point being a time point when the image collecting device captures the target object,
acquire second capture image information of the at least one companion,
analyze the second capture image information to obtain a second analysis result,
determine at least one second track of the at least one companion according to the second analysis result,
the second analysis result comprising appearing information of the at least one companion.

15. The device of claim 13, wherein the processor is further configured to:
determine a to-be-analyzed capture image based on the first capture image information;
determine the appearing information of the target object in each of the capture images, the appearing information comprising at least an appearing geographic location and an appearing time; and
count, based on the appearing information, a number of appearances of the target object in a same geographic location.

16. The device of claim 15, wherein the first analysis result further comprises at least one of the following:
correspondence between each of the capture images and the appearing information in the capture image; or
an association of each of the capture images with M neighboring capture images previous and following the capture image, M being a positive number.

17. The device of claim 15, wherein the processor is further configured to:
mark, on an electronic map based on the appearing information of the target object, appearing points and the numbers of appearances of the target object; and
connect the appearing points on the electronic map according to the appearing time to form the first track.

18. The device of claim 14, wherein the processor is further configured to:
determine a first companion among the at least one companion of the target object;
retrieve a second track of the first companion; and
perform comparative display on the first track of the target object and the second track of the first companion.

19. The device of claim 13, wherein the processor is further configured to:
perform clustering processing on image data in a first database to obtain a clustering processing result, the first database being formed based on portrait images captured by an image collecting device;
perform aggregation processing on image data in a second database to obtain an aggregation processing result, the second database being formed based on real-name image information; and
perform association analysis on the clustering processing result and the aggregation processing result to obtain aggregated profile data.

20. A computer storage medium, having computer programs stored thereon, when the computer programs are executed by a processor, the processor is configured to perform:
determining a target object based on aggregated profile data;
acquiring first capture image information of the target object;
analyzing the first capture image information to obtain a first analysis result; and
determining a first track of the target object according to the first analysis result, the first analysis result comprising appearing information of the target object.
